(19) United States
(12) Patent Application Publication
(10) Pub. No.: US 2025/0327442 A1
(43) Pub. Date: Oct. 23, 2025

(54) ONLINE TESTING AND DIAGNOSIS METHOD FOR VIBRATION CHARACTERISTICS OF BLADES OF WIND TURBINE

(71) Applicants: Inner Mongolia University of Technology, Hohhot (CN); ORDOS INSTITUTE OF TECHNOLOGY, Ordos City (CN)

(72) Inventors: Xin Jiang, Hohhot (CN); Peiyong Ren, Hohhot (CN); Shufeng Lv, Hohhot (CN); Hailong Qiao, Hohhot (CN); Ziyu Wang, Hohhot (CN); Guoyu Wang, Hohhot (CN); Ruofan Sun, Hohhot (CN); Jiayi Sun, Hohhot (CN)

(73) Assignees: Inner Mongolia University of Technology, Hohhot (CN); ORDOS INSTITUTE OF TECHNOLOGY, Ordos City (CN)

(21) Appl. No.: 19/256,078

(22) Filed: Jun. 30, 2025

(30) Foreign Application Priority Data
Jul. 2, 2024 (CN) 202410874016.9

(51) Int. Cl. F03D 17/00; G08B 21/18

(52) U.S. Cl. CPC F03D 17/015; F03D 17/0065; F03D 17/028; G08B 21/182; F05B 2260/80

(57) ABSTRACT

An online testing and diagnosis method for vibration characteristics of blades of wind turbine is disclosed. Steps of testing and diagnosing blade vibration comprises: S1: installing vibration sensors at key positions of a blade, designing an adaptive data acquisition strategy, and automatically adjusting a sampling rate according to a vibration amplitude and environmental changes monitored in a real time; S2: extracting key features reflecting health status of the blade from massive data, and evaluating an impact of wind speed, temperature, and environmental factors on vibration characteristics; S3: designing a customized deep learning model for damages of the blade of a wind turbine, extracting a time sequence data and a vibration signal, identifying a damage among different types of damages and evaluating a damage degree; and S4: automatically adjusting a warning threshold based on a real-time data stream and a historical trend, and drafting a preventive maintenance plan.

### CROSS REFERENCE TO RELATED APPLICATION(S)

This patent application claims the priority of Chinese Patent Application No. 202410874016.9 filed on Jul. 2, 2024, and entitled “ONLINE TESTING AND DIAGNOSIS METHOD FOR VIBRATION CHARACTERISTICS OF BLADES OF WIND TURBINE”, the disclosure of which is incorporated by reference herein in its entirety.

### TECHNICAL FIELD

The present disclosure relates to the technical field of wind power generation diagnosis, particularly to an online testing and diagnosis method for vibration characteristics of blades of wind turbine.

### BACKGROUND ART

With the increasing global demand for renewable energy sources, wind energy has developed rapidly as a clean and renewable energy source. Specifically, wind turbines are being deployed on an increasingly large scale. As a key component of a wind power generation system, size, weight, material, and design complexity of blades are constantly increasing. Moreover, with the increase of size of blades, the dynamic load that each blade bears under complex wind conditions significantly increases, which proposes a higher requirement on safety of the structure and long-term reliability of the blade.

Currently, vibration issues affecting blades are an area in which diagnostic capabilities need to be focused. Vibration of the blade not only affects power generation efficiency, but may also cause fatigue damage, cracks, and even fractures. In severe cases, the vibration of the blade may lead to a failure of the entire wind turbine, increasing maintenance costs, and affecting the safe operations and economic benefits of a wind field. Therefore, how to accurately monitor and diagnose the vibration characteristics of the blade becomes an urgent problem to be solved in the field of wind power generation.

Chinese patent number CN113029480B discloses a blade fatigue testing method and system for wind turbines. Compared with the prior art, the invention patent with the Chinese patent number CN113029480B can accurately calculate the specific positions and weights of excitation points and bob-weight points in advance. Therefore, there is no need to adjust and optimize during the testing stage, saving testing resources and time, making the test load closer to the actual load, resulting in more accurate test results, and shortening the testing cycle.

However, while shortening the testing cycle, it is also necessary to pay attention to the situations where the blades of the generator will suffer from erosion, cracks, or impact damage during a long-term operation in the natural environments. Currently, for this phenomenon, human observation is mainly relied on. When this phenomenon is discovered by the human, the overall wind turbine has already been impacted. Blade damage can lead to a decrease in aerodynamic performance, affect wind energy conversion efficiency, and reduce power generation. The damaged blade also can change its vibration frequency and mode of vibration, increasing the vibration amplitude and posing a threat to the structural safety of the entire wind turbine. Therefore, a remote testing and diagnosis method for vibration characteristics of blades of wind turbine is proposed here.

### SUMMARY

The purpose of the present disclosure is to propose an online testing and diagnosis method for vibration characteristics of blades of wind turbine in order to solve the disadvantage of mainly relying on human observation of blade state in the prior art.

In order to achieve the above objectives, the present disclosure adopts the following technical solution.

An online testing and diagnosis method for vibration characteristics of blades of wind turbine is provided. Steps of testing and diagnosing blade vibration are as follows:
S1: installing vibration sensors at key positions of a blade, designing an adaptive data acquisition strategy by utilizing a multimodal sensor data, and automatically adjusting a sampling rate according to a vibration amplitude and environmental changes monitored in a real time;
S2: extracting key features reflecting health status of the blade from the vibration amplitude and environmental changes by utilizing a signal processing technology to evaluate an impact of wind speed, temperature, and environmental factors on vibration characteristics;
S3: designing a customized deep learning model for damages of the blade of a wind turbine, extracting a time sequence data and a vibration signal from the vibration amplitude and environmental changes to identify a damage among different types of damages such as erosion, crack, and impact and evaluate a damage degree;
S4: automatically adjusting a warning threshold based on the vibration amplitude and environmental changes monitored in a real time and a historical trend of the vibration amplitude and environmental changes, and drafting a preventive maintenance plan based on analysis of damage prediction and vibration mode.

In S1, key positions of the blade that are most prone to damage, such as root, tip, middle, and known weak points of the blade, are determined. Different types of vibration sensors and environmental parameter sensors are installed at these key positions. And an algorithm is designed to dynamically adjust the sampling rate based on a vibration amplitude threshold and environmental parameter changes.

In S1, if a current vibration amplitude V_{current} is larger than a preset threshold Vₜₕ, a sampling rate F_{adjust} is adjusted according to a proportion exceeding the preset threshold Vₜₕ. A formula for adjusting vibration range is expressed as:

$${F}_{adjust} = {F}_{base} + ( \frac{{V}_{current} - {V}_{th}}{Δ V} ) \times ( {F}_{max} - {F}_{base} )$$

ΔV is an adjustment factor within a threshold range of a vibration amplitude, and is used to control a gradient of an adjustment.

Environmental parameter adjustment is to dynamically adjust the sampling rate based on changes of environmental parameters. If a change between a current wind speed W_{current} and a previous moment wind speed Wₚᵣₑᵥ exceeds Eₛₑₙₛ, the sampling rate is adjusted according to a ratio of wind speed changes:

$${F}_{env \_ adjust} = {F}_{base} + \frac{\vert {W}_{current} - {W}_{prev} \vert - {E}_{sens}}{Δ W} \times ( {F}_{max} - {F}_{base} )$$

ΔW is an adjustment factor of wind speed changes;
F_{base} represents a basic sampling rate, which is a default sampling rate under no effects of wind speed changes;
Fₘₐₓ: an allowed maximum sampling rate, represents a highest sampling rate limitation that a system can process.

When the vibration amplitude exceeds the preset threshold or environmental conditions change dramatically, the sampling rate is increased to capture more details; on a contrary, the sampling rate is reduced during smooth operation to save resources.

In S2, a relationship model between features is established by analyzing experiment data or historical data of the vibration amplitude and environmental changes. A measured value of a vibration parameter and a measured value of an environmental parameter are inputted into a corresponding compensation model to calculate an expected “environmental impact vibration feature” under current environmental condition. A main influence of wind speed on vibration of the blade is approximately represented as a linear relationship. The compensation model is expressed as:

$${V}_{corr \_ wind} ( f ) = {k}_{v} \times {V}_{actual}$$

V_{corr}_{_{wind}}(f) is a corrected value of the vibration amplitude under an effect of the wind speed, kᵥ is an effect coefficient of the wind speed, and V_{actual} is a measured wind speed.

A corrected vibration feature is obtained by subtracting the calculated “environmental impact vibration feature” from an original vibration feature. The corrected vibration feature is performed with an in-depth analysis to evaluate a health status of the blade.

In S2, the vibration parameter and the environmental parameter are corrected. An amplitude of original vibration signal at frequency ff is A_{raw}(f). A corrected wind speed obtained by the compensation model is V_{corr_wind}(f), and a corrected temperature obtained by the compensation model is T_{corr}(f). A corrected amplitude feature is expressed as:

$${A}_{corrected} ( f ) = {A}_{raw} ( f ) - {V}_{{corr}_{wind}} ( f ) - {T}_{corr} ( f )$$

A_{corrected}(f): represents a corrected vibration amplitude under frequency f;
A_{raw}(f): represents a vibration amplitude under frequency f obtained by an original measure;
V_{corr_wind}(f): represents a corrected value of effect of wind speed on vibration; and
T_{corr}(f): represents a corrected value of effect of temperature on vibration.

An expected vibration effect caused by changes in wind speed and changes in temperature is subtracted from an original vibration amplitude, and a prediction model is established based on the corrected vibration feature.

In S3, the corrected vibration feature and a vibration amplitude corrected by wind speed are organized to be a time sequence data format. Each sample of the time sequence data format includes a time sequence data and a damage state label such as without damage, erosion, crack, or impact corresponding to the time sequence data. Historical data of the blade is labeled with a type of a damage and a damage degree according to physical inspection, ultrasonic detection, and visual inspection methods. A time sequence analysis is performed based on a one-dimensional convolutional neural network model. A convolutional layer of the one-dimensional convolutional neural network model is represented as: y=f(b+W*x)

where f is an activation function, b is a bias term, W is a weight of convolutional kernel, and x is an inputting signal.

A periodic feature, a trending feature, and an instantaneous feature of a time sequence are extracted by utilizing a time sequence analysis.

In S3, damage degree is evaluated based on the features extracted by utilizing the deep learning model. An output layer of the deep learning model is modified to output a continuous value. The deep learning model is trained by utilizing a loss function of a regression task, to predict a damage degree. The damage degree is divided into several levels. A type and a level of the damage are also predicted. On a basis of a classification model, a regression model of the damage degree is further established for each type of damage, and a trained model is deployed to a wind turbine blade health monitoring system to analyze a vibration data of a blade in a real time and automatically identify the type of damage and the damage degree.

In S4, a trend of vibration feature over time is analyzed based on historical vibration data and known damage events, vibration feature patterns under different types of damage are identified. A dynamic threshold model is set. A warning threshold is dynamically adjusted according to a real-time data and a prediction model output. The warning threshold is set as one standard deviation of a normal vibration feature prediction interval or set as outside a specific percentile of the normal vibration feature prediction interval. A health status and potential risks of the blade are evaluated according to a deviation degree between a damage prediction result and a vibration feature. Different maintenance trigger thresholds are set according to a risk level. A minor deviation from the normal range may only require enhanced monitoring, while a severe deviation may require immediate inspection or repair arrangements.

The present disclosure has following beneficial effects.

In the present disclosure, an early warning can be issued at the early stage of damage formation by a real-time monitoring of vibration characteristics of a blade, and preventive maintenance measures can be taken to avoid high maintenance costs and long-term downtime losses caused by sudden failures, achieving early warning and prevention.

In the present disclosure, by introducing a deep learning model for testing and diagnosis, it is possible to learn complex blade vibration patterns from massive data, identify small abnormal changes, and adapt to different wind field environments and types of wind turbine. Even when environmental conditions change, it can maintain high diagnosis efficiency, achieve preventive maintenance, reduce unplanned downtime, and improve wind field operation efficiency.

### BRIEF DESCRIPTION OF THE DRAWINGS

FIG. 1 shows a diagram of method steps of an online testing and diagnosis method for vibration characteristics of blades of wind turbine proposed by the present disclosure.

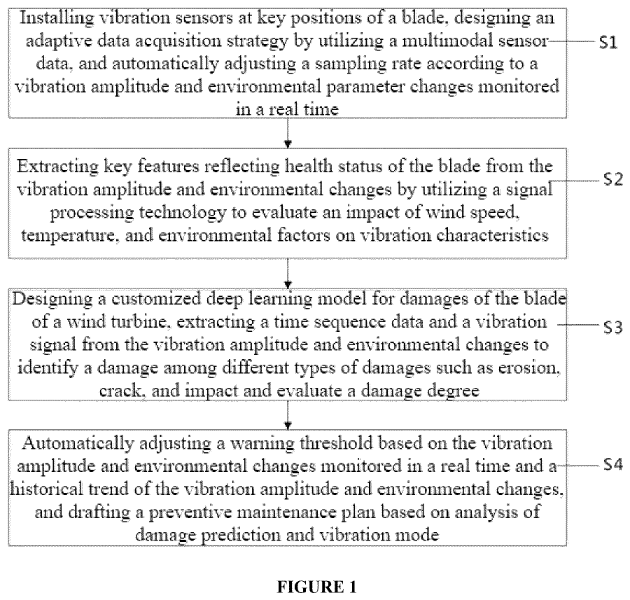

S1: installing vibration sensors at key positions of a blade, designing an adaptive data acquisition strategy by utilizing a multimodal sensor data, and automatically adjusting a sampling rate according to a vibration amplitude and environmental parameter changes monitored in a real time;

S2: extracting key features reflecting health status of the blade from the vibration amplitude and environmental changes by utilizing a signal processing technology to evaluate an impact of wind speed, temperature, and environmental factors on vibration characteristics;

S3: designing a customized deep learning model for damages of the blade of a wind turbine, extracting a time sequence data and a vibration signal from the vibration amplitude and environmental changes to identify, a damage among different types of damages such as erosion, crack, and impact and evaluate a damage degree; and

S4: automatically adjusting a warning threshold based on the vibration amplitude and environmental changes monitored in a real time and a historical trend of the vibration amplitude and environmental changes and drafting a preventive maintenance plan based on analysis of damage prediction and vibration mode.

### DETAILED DESCRIPTION OF THE EMBODIMENTS

The following will provide a clear and complete description of the technical solution in the embodiments of the present disclosure in conjunction with the accompanying drawings. Obviously, the described embodiments are only a part of the embodiments of the present disclosure, not all of them. Based on the embodiments of the present disclosure, all other embodiments obtained by ordinary skills in the art without creative labor are within the scope of protection of the present disclosure.

### Embodiment 1

As shown in the FIGURE, an online testing and diagnosis method for vibration characteristics of blades of wind turbine is proposed by the present disclosure. steps of testing and diagnosing blade vibration are as follows.

In S1, vibration sensors are installed at key positions of a blade. An adaptive data acquisition strategy is designed by utilizing a multimodal sensor data, and a sampling rate is automatically adjusted according to a vibration amplitude and environmental changes monitored in a real time.

In S2, key features reflecting health status of the blade are extracted from massive data by utilizing a signal processing technology to evaluate an impact of wind speed, temperature, and environmental factors on vibration characteristics.

In S3, a customized deep learning model for damages of the blade of a wind turbine is designed to extract a time sequence data and a vibration signal and to identify a damage among different types of damages such as erosion, crack, and impact and evaluating a damage degree.

In S4, a warning threshold is automatically adjusted based on a real-time data stream and a historical trend. A preventive maintenance plan is drafted based on analysis of damage prediction and vibration mode.

In S1, key areas of the blade that are most prone to damage, such as root, tip, middle, and known weak points of the blade, are determined. Different types of vibration sensors and environmental parameter sensors are installed at these key positions. An algorithm is designed to dynamically adjust the sampling rate based on a vibration amplitude threshold and environmental parameter changes.

In S1, if a current vibration amplitude V_{current} is larger than a preset threshold Vₜₕ, a sampling rate F_{adjust} is adjusted according to a proportion exceeding the preset threshold Vₜₕ, a formula for adjusting vibration range is expressed as:

$${F}_{adjust} = {F}_{base} + ( \frac{{V}_{current} - {V}_{th}}{Δ V} ) \times ( {F}_{max} - {F}_{base} )$$

ΔV is an adjustment factor within a threshold range of a vibration amplitude, and is used to control a gradient of an adjustment.

Environmental parameter adjustment is to dynamically adjust the sampling rate based on changes of environmental parameters. If a change between a current wind speed W_{current} and a previous moment wind speed Wₚᵣₑᵥ exceeds Eₛₑₙₛ, the sampling rate is adjusted according to a ratio of wind speed changes:

$${F}_{env \_ adjust} = {F}_{base} + \frac{\vert {W}_{current} - {W}_{prev} \vert - {E}_{sens}}{Δ W} \times ( {F}_{max} - {F}_{base} )$$

ΔW is an adjustment factor of wind speed changes;
F_{base} represents a basic sampling rate, which is a default sampling rate under no effects of wind speed changes;
Fₘₐₓ: an allowed maximum sampling rate, represents a highest sampling rate limitation that a system can process.

When the vibration amplitude exceeds the preset threshold or environmental conditions change dramatically, the sampling rate is increased to capture more details; on a contrary, the sampling rate is reduced during smooth operation to save resources.

In S2, a relationship model between features is established by analyzing experiment data or historical data. A measured value of a vibration parameter and a measured value of an environmental parameter are inputted into a corresponding compensation model to calculate an expected “environmental impact vibration feature” under current environmental condition. A main influence of wind speed on vibration of the blade is approximately represented as a linear relationship. The compensation model is expressed as:

$${V}_{corr \_ wind} ( f ) = {k}_{v} \times {V}_{actual}$$

V_{corr}_{_{wind}}(f) is a corrected value of the vibration amplitude under an effect of the wind speed, kᵥ is an effect coefficient of the wind speed, and V_{actual} is a measured wind speed.

A corrected vibration feature is obtained by subtracting the calculated “environmental impact vibration feature” from an original vibration feature. The corrected vibration feature is performed with an in-depth analysis to evaluate a health status of the blade.

In S2, the vibration parameter and the environmental parameter are corrected. An amplitude of original vibration signal at frequency ff is A_{raw}(f). A corrected wind speed obtained by the compensation model is V_{corr_wind}(f), and a corrected temperature obtained by the compensation model is T_{corr}(f). A corrected amplitude feature is expressed as:

$${A}_{corrected} ( f ) = {A}_{raw} ( f ) - {V}_{{corr}_{wind}} ( f ) - {T}_{corr} ( f )$$

A_{corrected}(f): represents a corrected vibration amplitude under frequency f;
A_{raw}(f): represents a vibration amplitude under frequency f obtained by an original measure;
V_{corr_wind}(f): represents a corrected value of effect of wind speed on vibration; and
T_{corr}(f): represents a corrected value of effect of temperature on vibration.

An expected vibration effect caused by changes in wind speed and changes in temperature is subtracted from an original vibration amplitude, and a prediction model is established based on a corrected feature.

In the embodiment, in S1, the influence of vibration amplitude and environmental parameters are taken into account. A larger value between the adjusted results of the vibration amplitude and environmental parameters, or a weighted average of the two adjusted results of the vibration amplitude and environmental parameters is taken as a final adjusted sampling rate:

$${F}_{final} = max ( {F}_{adjust} , {F}_{env \_ adjust} ) .$$

A wind turbine blade health monitoring system is designed. A warning threshold is needed to be adjusted according to blade vibration frequency and environmental factors, to prevent blade damage.

F_{adjust} represents an adjusted frequency based on analysis of vibration characteristics of the blade. For example, by analyzing blade vibration data, it is found that when the vibration frequency exceeds a certain threshold (based on historical data and damage cases), it indicates a possible risk of damage, and this threshold may be adjusted with subtle changes in vibration characteristics (such as changes in amplitude and frequency components).

F_{env_adjust} represents an adjusted frequency based on environmental factors. It is considered that an increase in wind speed can lead to intensified blade vibration, but this intensification is a normal physical reaction and not a sign of damage. To eliminate the influence of such normal changes, we calculate an adjusted threshold based on current wind speed and temperature conditions to reflect the upper limit of “normal” vibration under specific environmental conditions.

F_{adjust}=50 Hz is an initial warning threshold set based on analysis of blade vibration data.

After adjusting for the environmental impact under the current wind speed of 20 m/s and temperature of 25° C., it is believed that the blade vibration frequency should not exceed this value (55 Hz) under these environmental conditions.

Based on the formula F_{final}=max (F_{adjust}, F_{env_adjust}), the final warning threshold F_{final} would be the larger value between the F_{adjust} and the F_{env_adjust}, which means that under the current environmental condition, even if the threshold based on vibration characteristic analysis is low, the threshold adjusted for environmental factors should be used to avoid misjudgment and ensure the safe operation of the blade in harsh environments.

### Embodiment 2

As shown in the FIGURE, on the basis of the Embodiment 1, in S3, a time sequence data format is organized based on a corrected vibration signal and a vibration amplitude corrected by wind speed. Each sample of the time sequence data format includes a time sequence data and a damage state label such as without damage, erosion, crack, or impact corresponding to the time sequence data. Historical data of the blade is labeled with a type of a damage and a damage degree according to physical inspection, ultrasonic detection, and visual inspection methods. A time sequence analysis is performed based on a one-dimensional convolutional neural network model. A convolutional layer of the one-dimensional convolutional neural network model is represented as:

$$y = f ( b + W * x )$$

where f is an activation function, b is a bias term, W is a weight of convolutional kernel, and x is an inputting signal.

A periodic feature, a trending feature, and an instantaneous feature of a time sequence are extracted by utilizing a time sequence analysis.

In S3, based on the features extracted by utilizing the deep learning model, for damage degree evaluation, an output layer of the deep learning model is modified to output a continuous value, a train is performed by utilizing a loss function of a regression task, to predict a damage degree. The damage degree is divided into several levels. A type and a level of the damage are also predicted. On a basis of a classification model, a regression model of the damage degree is further established for each type of damage. A trained model is deployed to a wind turbine blade health monitoring system to analyze a vibration data of a blade in a real time and automatically identify the type of damage and the damage degree.

In S4, a trend of vibration feature over time is analyzed based on historical vibration data and known damage events. Vibration feature patterns under different types of damage are identified. A dynamic threshold model is set, and a warning threshold is dynamically adjusted according to a real-time data and a prediction model output. The warning threshold is set as one standard deviation of a normal vibration feature prediction interval. A health status and potential risks of the blade are evaluated according to a deviation degree between a damage prediction result and a vibration feature. Different maintenance trigger thresholds are set according to a risk level. A minor deviation from the normal range may only require enhanced monitoring, while a severe deviation may require immediate inspection or repair arrangements.

In this embodiment, the construction process of the one-dimensional convolutional neural network (1D CNN) model is as follows.

Firstly, the numerical ranges of the vibration signal and environmental parameters are uniformly scaled. The vibration amplitude is normalized to between [0, 1]. Then, sequence slicing is performed to divide the continuous vibration signal into fixed length sequences as inputs to the model.

Input layer: the shape of which is the sequence length and the number of channels. The number of channels depends on whether environmental parameters are added as additional input dimensions.

Convolutional layer: a one-dimensional convolutional kernel is used.

Activation function: ReLU(f(x)=max(0, x)), which is used to increase the nonlinearity of the model.

Fully connected layer: which is used to map the features output by the convolutional layer to the space of classification or regression problems, such as 128 neurons.

Output layer: which is depended according to tasks. If it is a classification task, a Softmax function is used to output probabilities for each category. If it is a regression task, a predicted value of the damage degree is directly output.

Loss function: if it is a classification task, a cross-entropy loss is used, and if it is a regression task, a mean square error (MSE) or a root mean square error (RMSE) is used.

Optimizer: Adam is selected, which is used for updating network weights.

The data is divided into a training set, a validation set, and a testing set. The model is then compiled, and the loss function, optimizer, and evaluation metrics are specified. The model parameters are optimized through backpropagation and gradient descent algorithms. Then the basic framework design of the model is completed.

Although the embodiments of the present disclosure have been shown and described, it will be understood by those skilled in the art that various changes, modifications, substitutions, and variations can be made to these embodiments without departing from the principles and spirit of the present disclosure. The scope of the present disclosure is limited by the appended claims and their equivalents.

What is claimed is:

1. An online testing and diagnosis method for vibration characteristics of wind turbine blades, characterized in that steps of testing and diagnosing blade vibration are as follows:
S1: installing vibration sensors at selected positions of a blade, designing an adaptive data acquisition strategy by utilizing a multimodal sensor data, and automatically adjusting a sampling rate according to a vibration amplitude and according to environmental parameter changes monitored in a real time;
S2: extracting selected features reflecting health status of the blade from the vibration amplitude and environmental changes by utilizing a signal processing technology to evaluate an impact of wind speed, temperature, and environmental factors on vibration characteristics;
S3: designing a customized deep learning model for damage to the blade of a wind turbine, extracting time sequence data and at least one vibration signal from the vibration amplitude and environmental changes to identify a type of damage among different types of damage including erosion, crack, and impact, and evaluate a damage degree; and
S4: automatically adjusting a warning threshold based on the vibration amplitude and environmental changes monitored in a real time and a historical trend of the vibration amplitude and environmental changes, and drafting a preventive maintenance plan based on analysis of predicted damage type and vibration mode;
in S2, establishing a relationship model between features by analyzing experimental data or historical data of the vibration amplitude and environmental changes, inputting a measured value of a vibration parameter and a measured value of an environmental parameter into a corresponding compensation model to calculate an expected “environmental impact vibration feature” under current environmental conditions, wherein a main influence of wind speed on vibration of the blade is approximated as a linear relationship, and the compensation model is expressed as:
$${V}_{corr \_ wind} ( f ) = {k}_{v} \times {V}_{actual}$$
wherein, V_{corr}_{_{wind}}(f) is a corrected value of the vibration amplitude under an effect of the wind speed, kᵥ is an effect coefficient of the wind speed, and V_{actual} is a measured wind speed;
wherein a corrected vibration feature is obtained by subtracting the calculated “environmental impact vibration feature” from an original vibration feature, and the corrected vibration feature is performed with an in-depth analysis to evaluate a health status of the blade.

2. The online testing and diagnosis method for vibration characteristics of wind turbine blades according to claim 1, characterized in that in S1, key positions of the blade that are most prone to damage, such as root, tip, middle, and known weak points of the blade, are determined; different types of vibration sensors and environmental parameter sensors are installed at these key positions, and an algorithm is designed to dynamically adjust the sampling rate based on a vibration amplitude threshold and environmental parameter changes.

3. The online testing and diagnosis method for vibration characteristics of wind turbine blades according to claim 1, characterized in that in S1, if a current vibration amplitude V_{current} is larger than a preset threshold Vₜₕ, a sampling rate F_{adjust} is adjusted according to a proportion exceeding the preset threshold Vₜₕ, a formula for adjusting vibration range is expressed as:
$${F}_{adjust} = {F}_{base} + ( \frac{{V}_{current} - {V}_{th}}{Δ V} ) \times ( {F}_{max} - {F}_{base} )$$
wherein ΔV is an adjustment factor within a threshold range of a vibration amplitude, and is used to control a gradient of an adjustment;
environmental parameter adjustment is to dynamically adjust the sampling rate based on changes of environmental parameters; if a change between a current wind speed W_{current} and a previous moment wind speed Wₚᵣₑᵥ exceeds Eₛₑₙₛ, the sampling rate is adjusted according to a ratio of wind speed changes:
$${F}_{env \_ adjust} = {F}_{base} + \frac{\vert {W}_{current} - {W}_{prev} \vert - {E}_{sens}}{Δ W} \times ( {F}_{max} - {F}_{base} )$$
wherein:
ΔW is an adjustment factor of wind speed changes;
F_{base} represents a basic sampling rate, which is a default sampling rate under no effects of wind speed changes;
Fₘₐₓ: an allowed maximum sampling rate, represents a highest sampling rate limitation that a system can process;
wherein, when the vibration amplitude exceeds the preset threshold or an environmental parameter changes dramatically, the sampling rate is increased to capture more details; and
wherein, when the vibration amplitude falls below a preset threshold, the sampling rate is reduced during smooth operation to save resources.

4. The online testing and diagnosis method for vibration characteristics of wind turbine blades according to claim 1, characterized in that in S2, the vibration parameter and the environmental parameter are corrected, an amplitude of original vibration signal at frequency ff is A_{raw}(f), a corrected wind speed obtained by the compensation model is V_{corr_wind}(f), and a corrected temperature obtained by the compensation model is T_{corr}(f), a corrected amplitude feature is expressed as:
$${A}_{corrected} ( f ) = {A}_{raw} ( f ) - {V}_{{corr}_{wind}} ( f ) - {T}_{corr} ( f )$$
wherein:
A_{corrected}(f): represents a corrected vibration amplitude under frequency f;
A_{raw}(f): represents a vibration amplitude under frequency f obtained by an original measure;
V_{corr_wind}(f): represents a corrected value of effect of wind speed on vibration;
T_{corr}(f): represents a corrected value of effect of temperature on vibration;
wherein an expected vibration effect caused by changes in wind speed and changes in temperature is subtracted from an original vibration amplitude, and a prediction model is established based on the corrected vibration feature.

5. The online testing and diagnosis method for vibration characteristics of wind turbine blades according to claim 1, characterized in that in S3, the corrected vibration feature and a vibration amplitude corrected by wind speed are organized to be in a time sequence data format, wherein each sample of the time sequence data format comprises a time sequence data and a damage state label selected from: without damage, erosion, crack, or impact corresponding to the time sequence data; wherein historical data of the blade is labeled with a type of a damage and a damage degree according to physical inspection, ultrasonic detection, and visual inspection methods; and a time sequence analysis is performed based on a one-dimensional convolutional neural network model;
wherein a convolutional layer of the one-dimensional convolutional neural network model is represented as: y=f(b+W*x)
wherein f is an activation function, b is a bias term, W is a weight of convolutional kernel, and x is an inputting signal;
and wherein a periodic feature, a trending feature, and an instantaneous feature of a time sequence are extracted by utilizing a time sequence analysis.

6. The online testing and diagnosis method for vibration characteristics of wind turbine blades according to claim 1, characterized in that in S3, damage degree is evaluated based on the features extracted by utilizing the deep learning model,
wherein an output layer of the deep learning model is modified to output a continuous value, the deep learning model is trained by utilizing a loss function of a regression task to predict a damage degree, the damage degree is divided into several levels, and a type and a level of the damage are also predicted;
wherein, on a basis of a classification model, a regression model of the damage degree is further established for each type of damage, and a trained model is deployed to a wind turbine blade health monitoring system to analyze a vibration data of a blade in a real time and automatically identify the type of damage and the damage degree.

7. The online testing and diagnosis of vibration characteristics of wind turbine blades according to claim 1, characterized in that in S4, a trend of vibration feature over time is analyzed based on historical vibration data and known damage events, vibration feature patterns under different types of damage are identified, a dynamic threshold model is set, and a warning threshold is dynamically adjusted according to a real-time data and a prediction model output;
wherein the warning threshold is set as one standard deviation of a normal vibration feature prediction interval, and a health status and potential risks of the blade are evaluated according to a deviation degree between a damage prediction result and a vibration feature;
wherein different maintenance trigger thresholds are set according to a risk level.
